(19) United States
(12) Patent Application Publication
(10) Pub. No.: US 2022/0386441 A1
(43) Pub. Date: Dec. 1, 2022

(54) DEVICE FOR CONTAINING AND ACCELERATING PLASMA WITHIN A MIXER/COMPRESSOR SYSTEM BY WAY OF MAGNETIC FORCES AND THE COANDA EFFECT

(71) Applicant: Brant von Goble, Lansing, MI (US)

(72) Inventor: Brant von Goble, Lansing, MI (US)

(21) Appl. No.: 17/334,840

(22) Filed: May 31, 2021

(51) Int. Cl. H05H 1/00

(52) U.S. Cl. CPC H05H 1/01

(57) ABSTRACT

A device for the containment, mixing, acceleration, and controlled release of fast-flowing ionized fluids or plasma, consisting of a grooved sphere with interior and surface electromagnets of opposing polarity and variable power output. The grooves within the device allow for extremely high rates of ionized fluid/plasma flow and mixing of either the same or differing compositions for each groove, depending upon the materials injected into them, and for the release of accelerated ionized fluid/plasma instantaneously and simultaneously (with all grooves depressurizing synchronously and unidirectionally), gradually and simultaneously (with all grooves gradually depressurizing at the same or different rates), or non-simultaneously and gradually or instantaneously (with the grooves depressurizing at different rates and times). The invention also provides a means of slowing ionized fluid/plasma flow within the grooves by way of the magnetohydrodynamic effect, which offers the potential for partial power recovery.

### CROSS REFERENCES TO RELATED APPLICATIONS

This application claims the benefits of U.S. Provisional Patent Application No. 63/199,733, filed Jan. 21, 2021, with the text of that claim incorporated herein.

This invention is intended to function within, but not exclusively within, the core of the invention described by U.S. Provisional Patent Application No. 63/064,419, filed Aug. 12, 2020, and later in U.S. Utility application Ser. No. 17,128,117, filed Dec. 20, 2020, with the relevant components of that invention illustrated as necessary in this application to demonstrate the relationship between the two devices, but without this application addressing or laying claim to any part of the invention described in U.S. Provisional Patent Application No. 63/064,419 and U.S. Utility application Ser. No. 17,128,117.

### BACKGROUND OF INVENTION

### Field of the Invention

The containment of fast-flowing ionized fluid/plasma is technically difficult. Conventional approaches to ionized fluid/ionized fluid/plasma containment rely almost exclusively on magnetic confinement, which requires significant amounts of electricity and complex electromagnet geometries. The small-channel/groove system herein makes use of a simplified, compact structure in which ionized fluid/ionized fluid/plasma is contained by comparatively low-power magnets and the Coandă effect.

The ability of magnetic fields to attract or repel ionized fluid/plasma is well known; however, the role of the Coandă effect in controlling the flow of fluid may be less so.

The Coandă effect causes fluids to flow along a curved surface without the use of power or other external manipulation. The effect works with fluids of a range of viscosities, temperatures, and flow rates.

This effect, combined with the magnetic attract/repel mechanism of the grooves, will allow for the sphere to contain and accelerate ionized fluid/plasma within its grooves and for the injection of additional ionized fluid/plasma into the grooves in an energy-efficient manner.

### Description of the Prior Art

Coandă Effect

The Coandă effect is the tendency of a jet of fluid to follow a nearby surface and stay attached to that surface. The effect occurs with both flat and curved surfaces but is considerably more pronounced with curved surfaces.

The Coandă effect has applications in fluid mixing, jet turbines, airplane wing design, fuel injection systems, cooking apparatuses, and fans and air-moving systems.

Patents and publications related to the Coandă effect are described, infra.

Z. Mocarski, “Fluid Device Using Coandă Effect,” U.S. Pat. No. 3,795,367 (Mar. 5, 1974) describes a device in which a small volume of fluid induces flow of a larger volume of fluid by way of the Coandă effect, with the two fluids mixing in this process.

J. Butera, et al., “Air-distribution Device Based on the Coandă Effect,” U.S. Pat. No. 7,000,640 B2 (Feb. 21, 2006) describes a device that uses the Coandă effect to direct air along curved ducts.

J. Xu, et al., “Cooling Hole with Enhanced Flow Attachment,” U.S. Pat. No. 10,487,666 B2 (Nov. 26, 2019) describes a component of a gas turbine engine that consists of a cooling hole extending through a wall surface, with the shape of that hole creating a thin film of cool air along said surface by way of the Coandă effect.

K. Simmonds, et al., “Fan Utilizing Coandă Surface,” U.S. Pat. No. 9,816,531 B2 (Nov. 14, 2017) describes a bladeless fan, in which air is expelled from a source (any device capable of creating a flow of air) and directed by a nozzle to an adjacent curved surface, which directs and distributes the air by way of the Coandă effect.

J. Orosa, et al., “Turbine Exhaust Diffuser with a Gas Jet Producing a Coandă Effect Flow Control,” U.S. Pat. No. 8,647,057 B2 (Feb. 11, 2014) describes a system in which a shaped hub causes the flow of exhaust from a jet engine to be directed towards a point, and away from the walls of the tail cone.

R. Darke, et al., “Recirculating Coandă Water Extractor,” U.S. Pat. No. 7,691,185 B2 (Apr. 6, 2010) describes a system that uses the Coandă effect to capture water droplets and recirculate them through a pumping system. Although the system is designed to remove entrained water from an airstream (rather than confine ionized fluid/plasma, as is the case with the present invention), it demonstrates the utility of using the Coandă effect to maintain a circular flow of fluid.

P. Lindgren, “Fish Pump,” U.S. Pat. No. 7,462,016 B2 (Dec. 9, 2008) describes a system for moving fish without causing damage to them by way of the Coandă effect. Although this is substantially different in function than is the present invention, it demonstrates the potential for fluid (without fish) to be injected into the grooves of the present invention by way of the pumping-line ports of the invention described in U.S. Utility application Ser. No. 17,128,117 and to transfer velocity developed in the fluid flow of the previous invention to velocity in the grooves of the present invention.

Ionized Fluid/Plasma Confinement

Amongst the many ways to contain ionized fluid/plasma, the application of magnetic fields is amongst the most popular. Although the fundamental operation is relatively similar from one invention to the next—strong magnetic fields are used to repel ionized fluid/plasma of an opposing polarity—the specifics of shape of coil and resultant shape of magnetic field differ greatly.

Patents and publications related to containment of ionized fluid/plasma by way of magnetic fields are described, infra.

T. Ohkawa, “Multiple Pinch Method and Apparatus for Producing Average Magnetic Well in Plasma Confinement,” U.S. Pat. No. 4,543,231 (Sep. 24, 1985) describes a method for containing ionized fluid/plasma using a multipole ionized fluid/plasma pinch method designed to concentrate the ionized fluid/plasma into points of considerable heat. Unlike the present invention, the method described provides no route for ordinary ionized fluid/plasma flow or acceleration.

J. Shelton, “Plasma Containment Device,” U.S. Pat. No. 4,654,561 (Mar. 31, 1987) describes a system for maintaining a ball of ionized fluid/plasma within a spherical enclosure by way of an electromagnetic field and opposing gas jets that both supply the ionized fluid/plasma ball with ionizable gas and that prevent the ionized fluid/plasma ball from contacting the device's electrodes.

J. Walko II, “Efficient Plasma Containment Structure,” U.S. Pat. No. 6,221,202 B1 (Apr. 24, 2001) describes a device for containing ionized fluid/plasma within a space by use of a plate, which has holes in it that allows for gas to flow freely through, and electromagnetic attenuation system that confines the field to the desired part of the structure and allows for the structure to maintain a high level of conductance.

W. Edwards, et al., “Ion-Mode Plasma Containment,” U.S. Pat. No. 9,125,288 B2 (Sep. 1, 2015) describes a sealed toroidal vessel in which ionized fluid/plasma is generated by way of an ionizing device and is contained by an electromagnetic field generated by coils wrapped poloidally about the vessel.

A. de la Llera, et al., “Plasma Confinement Ring Assembly for Plasma Processing Chambers,” U.S. Pat. No. 9,076,826 B2 (Jul. 7, 2015) describes a confinement system configured as a ring and used to maintain an ionized fluid/plasma reaction chamber. The device is divided into two sections—upper and lower—with the lower section being moveable to control the volume in which the ionized fluid/plasma is confined.

L. Li, et al., “Perforated Plasma Confinement Ring in Plasma Reactors,” U.S. Pat. No. 6,178,919 B1 (Jan. 30, 2001) describes a system for the confinement of ionized fluid/plasma by way of perforated rings, with the top and bottom sections of the rings being charged by way of RF power sources—the upper ring having a higher frequency source and the lower ring having a lower frequency RF source. Although the device is distinct from the present invention in that it (unlike the invention described within the present application) lacks an entirely open ionized fluid/plasma injection region, it does demonstrate the viability of having ionized fluid/plasma contained without the use of a solid outer boundary.

J. Cover, “Thermal Energy Conversion,” U.S. Pat. No. 4,486,701 (Dec. 4, 1984) provides a method of energy recovery by way of the magnetohydrodynamic effect in a circulating system. Although the device described is structurally distinct, it demonstrates a means of partial energy recovery for the present invention by way of the magnetohydrodynamic effect to allow for more efficient plasma confinement.

Switching/Pulsed Electromagnets

Control of the flow of ionized fluid/plasma within the present invention is to be done using individually controllable magnetic fields of adjustable power that can be either pulsed or operated continuously, depending upon the velocity, pressurization level, and duration of confinement desired. The mechanics of constructing appropriate electromagnets and electromagnet arrays can be easily ascertained by examining the prior art.

Patents and publications related to the construction of switching/pulsed electromagnets are described, infra.

R. Chistyakov, “High-Density Plasma Source Using Excited Atoms,” U.S. Pat. No. 6,806,652 B1 (Oct. 19, 2004) describes a device for creating ionized fluid/plasma by way of excited atoms, with the design characteristic relevant to the present invention being the use of switching electromagnets to direct particle flow, much as the switching magnets in the present invention are designed to do.

R. Lugg, “Magnetic Advanced Generation Jet Electric Turbine,” U.S. Pat. No. 8,365,510 B2 (Feb. 5, 2013) describes a hybrid turbomachine combining a gas turbine, a superconducting electrical power generation system, a magnetic flux field system, and an ion plasma injection combustor. Of relevance to the present invention is the use of sequentially spaced electromagnets to accelerate exhaust flow, much in the same way magnets within the present invention will accelerate plasma within its grooves.

Y. Shachar, et al., “Diagnostic and Therapeutic Magnetic Propulsion Capsule and Method for Using the Same,” U.S. Pat. No. 8,684,010 B2 (Apr. 1, 2014) describes a device that uses pulsed electromagnetic fields that interact with tissue within the human body to propel itself forward. The timed pulsation of the electromagnets within this device affords it greater motive power than it would have with continuously operating fields. Likewise, pulsing electromagnets within the invention described by the present application have the potential to accelerate the ionized fluid/plasma contained in its grooves in an efficient manner.

D. Miller, et al., “Systems and Methods for Plasma Jets,” U.S. Pat. No. 8,242,404 B2 (Aug. 14, 2012) describes a device in which the output of a plasma generator is directed to an electromagnetic accelerator of variable power, which directs the plasma towards an opening. The accelerator within the device and its variable-power control features are similar to the electromagnet system of the present invention's grooves, although both the layout and number of elements in each device are different.

Plasma Erosion

Embodiments of the present invention can be constructed of any suitable material, so long as it is sufficiently resistant to the effects of ongoing exposure to ionized fluids/plasma. Plasma erosion, in which surfaces exposed to flowing plasma degrade over time, stands to significantly shorten the lifespan of this invention, particularly embodiments intended to process plasma at high pressures and for substantial amounts of time. Several technologies exist to reduce the effect of plasma erosion.

Patents and publications related to plasma erosion are described, infra.

J. Sun, et al., “Plasma Erosion Resistant Rare-Earth Oxide Based Thin Film Coatings,” U.S. Pat. No. 9,850,568 B2 (Dec. 26, 2017) describes a ceramic film that can be sprayed on surfaces to prevent ceramic erosion. While this material (or any material like it) does not constitute a part of the present invention, it may be used in its construction, particularly if the materials used in the invention are not inherently resistant to plasma erosion.

T. Tran, et al., “Multi-Layer Plasma Erosion Protection for Chamber Components,” U.S. Pat. No. 10,755,900 B2 (Aug. 25, 2020) describes a method of applying a coating to prevent plasma erosion of surfaces. Using electron beam ion-assisted deposition, plasma-enhanced chemical vapor deposition, aerosol deposition, or plasma spraying, the coating can be made to variable thickness, with commensurate degrees of resistance to plasma erosion resulting thereof.

Inductive Power Transfer

Embodiments of the present invention may be powered by either direct (wired) electrical power transmissions or they may be powered by a contactless system that allows the invention to float (or be magnetically levitated) in the invention described in U.S. Utility application Ser. No. 17,128,117. Additionally, any surplus power generated by way of the magnetohydrodynamic effect may be returned to the invention described in U.S. Utility application Ser. No. 17,128,117 by either direct or inductive means.

Patents and publications related to inductive power transfer are described, infra.

A. Van Wageningen, et al., “Wireless Inductive Power Transfer,” U.S. Pat. No. 10,778,048 B2 (Sep. 15, 2020) describes a wireless power transmission system consisting of a transmitter and a receiver, with each section acting as half of an electrical transformer, and a complex electronic-control system to prevent overheating of the device or over- or under-powering of systems attached to the device. Although this system is designed for far lower power levels than what would be used in the invention described in the present application, a similar electronic control system may be used to automatically regulate power transfer between embodiments of the present invention and embodiments of the invention described in U.S. Utility application Ser. No. 17,128,117 (as illustrated in FIG. 12 and FIG. 13 of this application).

D. Baarman, “Coil Configurations for Inductive Power Transfer,” U.S. Pat. No. 9,054,542 B2 (Jun. 9, 2015) describes an inductive power transfer device in which the receiving coils are attached to a plurality of resonating circuits, which serve to improve the efficiency of power transfer at a range of distance. A similar system may be attached to either certain embodiments of the present invention or certain embodiments of the invention described in U.S. Utility application Ser. No. 17,128,117 to improve power transfer efficiency between the devices at a range of distances, which may vary based upon changes to the precise placement of the present invention within the invention described in U.S. Utility application Ser. No. 17,128,117.

Y. Azancot, et al., “Transmission-Guard System and Method for an Inductive Power Supply,” U.S. Pat. No. 9,685,795 B2 (Jun. 20, 2017) describes a system for the wireless transfer of power by way of electrical induction, with a voltage monitoring and control system that is intended to reduce energy loss at higher power levels. Although the invention described by Azancot is designed for consumer applications, the underlying voltage regulation system has the potential to prove useful in the electromagnetic coupling of certain embodiments of the present and the invention described in U.S. Utility application Ser. No. 17,128,117.

### SUMMARY OF INVENTION

The invention is made of several parts, which are components of a grooved sphere, consisting of electromagnets of opposing polarity and variable power (inside and at the boundary of the grooves) and a temperature-resistant, electromagnetically inert matrix.

The unique geometry of the grooves of the sphere allows for the containment of fast-flowing ionized fluid/plasma by way of both magnetic forces and the Coand\check{a} effect, at lower electromagnet power levels than would be possible using conventional groove geometries or smooth-surface containment systems. Inflow and outflow of ionized fluid/plasma to the sphere grooves is controlled by varying the power of the outer/surface layer of electromagnets. All electromagnets (inner and outer layer) are divided into 20 individually controlled sections of equal arc length, although a different number of sections (with different arc lengths) could be implemented in other embodiments of this invention.

Within the embodiment of the invention described herein, the ionized fluid/plasma is assumed to be negatively charged, with the outer walls/outer boundaries of the containment grooves negatively charged and the inner/lower/closer-to-the-sphere core section of the containment grooves positively charged; however, the invention would be equally effective if all polarities and ionization were reversed.

### DESCRIPTION OF DRAWINGS OF INVENTION

The patent or application file contains at least one drawing executed in color. Copies of this patent or patent application publication with color drawing(s) will be provided by the Office upon request and payment of the necessary fee.

The features, aspects, advantages, and operation of the present invention will become better understood by referencing the appended descriptions and claims, and the accompanying drawings wherein:

FIG. 1 is a cross-sectional view of an embodiment of the invention, indicating the dimensions of the embodiment and the placement, general shape, and number of grooves on the embodiment.

FIG. 2 is a close-up view of the section of an embodiment of the invention as highlighted in 101 (FIG. 1), clearly indicating the distinctive shape of the grooves, the polarity of different sections of the grooves, and the flow of ionized fluid/plasma (as indicated by arrows with polarity marks) into the grooves.

FIG. 3 is an additional close-up view of the section of the embodiment of the invention, providing another illustration of the shape of the grooves around the invention.

FIG. 4 is an opposing-angle view of the section of the embodiment of the invention, illustrating the flow of ionized fluid/plasma contained in the grooves.

FIG. 5 is a close-up dimetric northwest (NW) view of a section of one groove, showing the deflection of an ionized fluid/plasma stream as it enters the groove, with the entry ionized fluid/plasma stream (dotted orange line) and the internal ionized fluid/plasma stream (solid red line) both clearly illustrated.

FIG. 6 is a top-down view of the entire embodiment of the invention.

FIG. 7 is a side view of the entire embodiment of the invention.

FIG. 8 is a top-down view of the division of the embodiment of the invention into control sections, with the red lines dividing the system being purely illustrative of the arc dimensions of the sections, not representing physically present lines.

FIG. 9. and FIG. 10 are side and isometric views of the embodiment of the invention divided into control sections (red lines).

FIG. 11 is a close-up dimetric northwest (NW) view of the embodiment of the invention placed within the core of the invention described in U.S. Utility application Ser. No. 17,128,117, in which the present invention is designed to operate (amongst other environments).

FIG. 12 is a cutaway close-up dimetric northwest (NW) view of the embodiment of the invention placed within the core of the invention described in U.S. Utility application Ser. No. 17,128,117, in which the present invention is designed to operate, clearly illustrating the alignment of that invention's pumping-line ports (as illustrated by the colored lines) and the present invention's grooves.

FIG. 13 demonstrates the precise dimensions of the invention described in U.S. Utility application Ser. No. 17,128,117 and the dimensions and placement within that invention of the embodiment of the invention described herein.

Explanation of Points Illustrated by Drawings of Invention

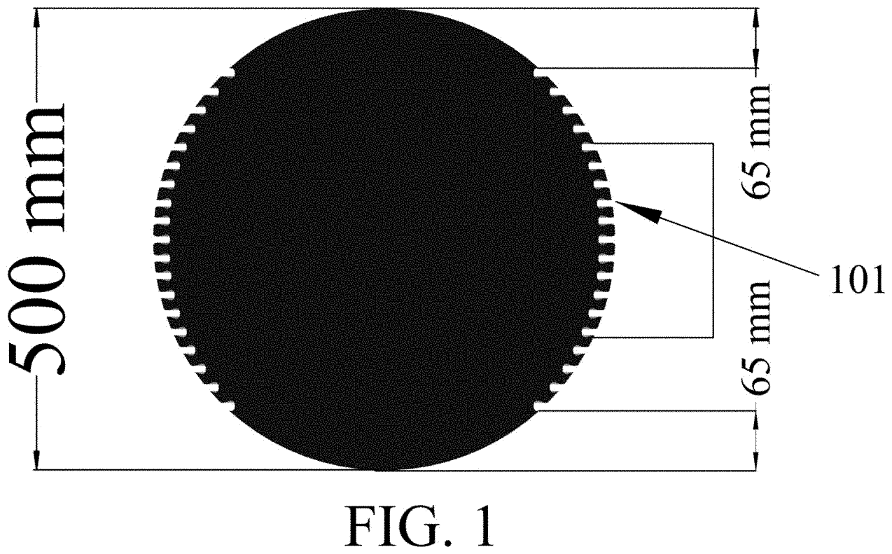

The preferred embodiment of the present invention is illustrated in FIG. 1 through FIG. 13, with each drawing demonstrating a different aspect of said invention.

FIG. 1 is a cross-sectional view of an embodiment of the invention, indicating the dimensions of the embodiment and the placement, general shape, and number of grooves on the embodiment.

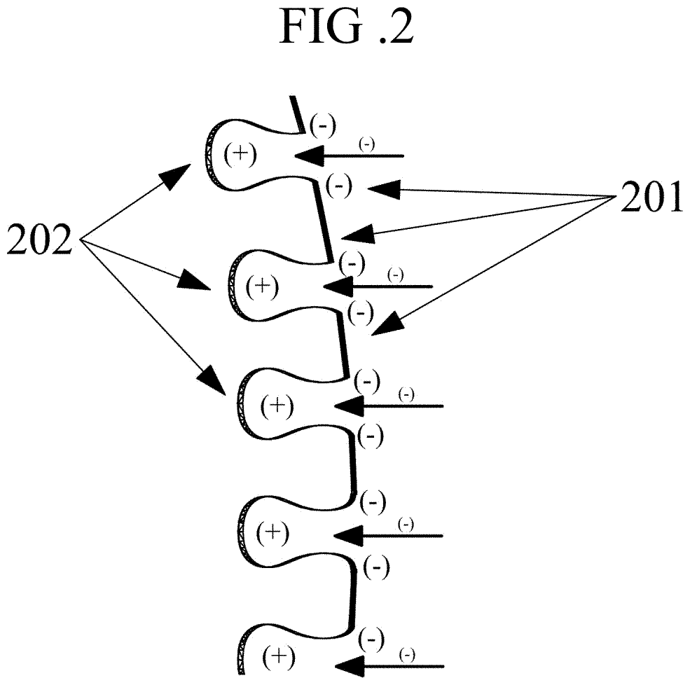

FIG. 2 provides a cross-sectional closeup of the section illustrated in 101 (FIG. 1) and the polarity of the inner and outer regions of the grooves, assuming the ionized fluid/plasma the embodiment is designed to contain is negatively charged.

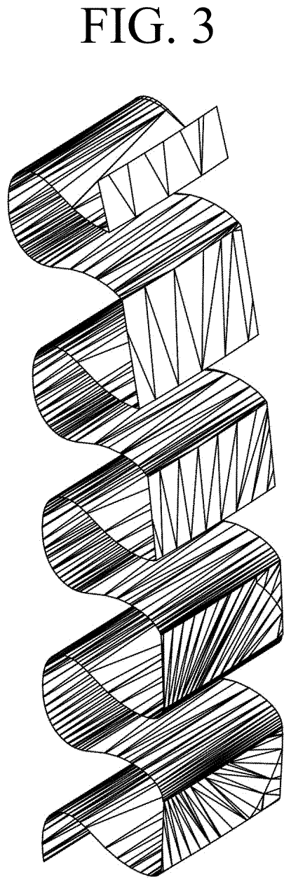

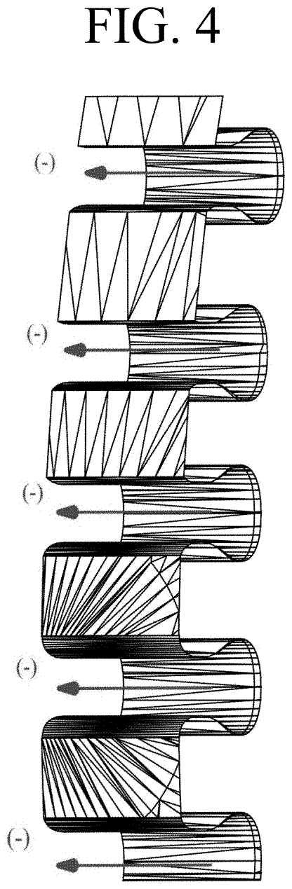

FIG. 3 and FIG. 4 show the grooves selected from 101 from several different angles, illustrating both the distinctive shape of the grooves and the flow of confined ionized fluid/plasma through the grooves.

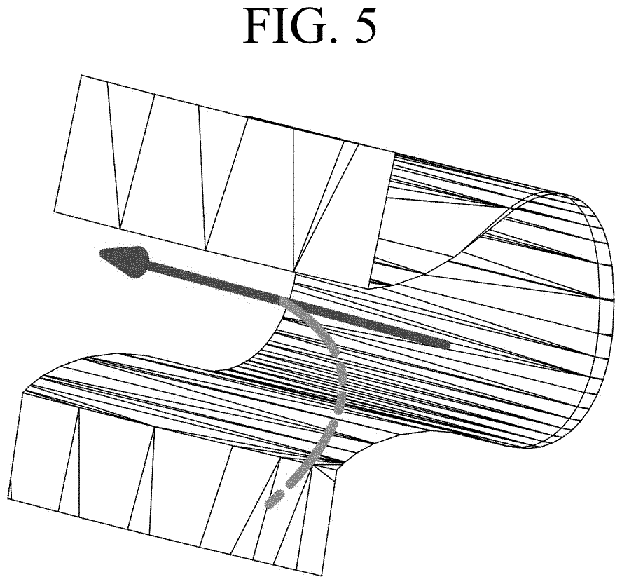

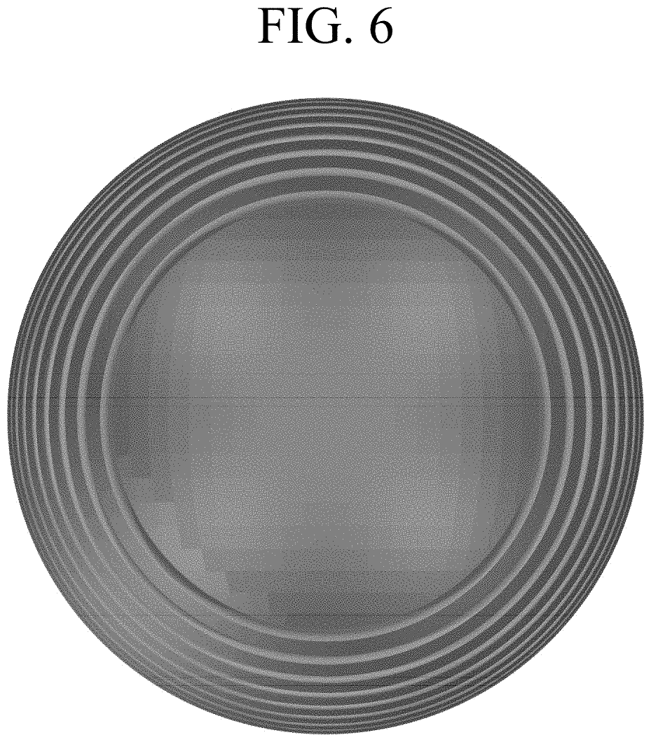

FIG. 5 illustrates the distortion/deflection of an ionized fluid/plasma stream as it enters the groove and integrates into the internal ionized fluid/plasma stream.

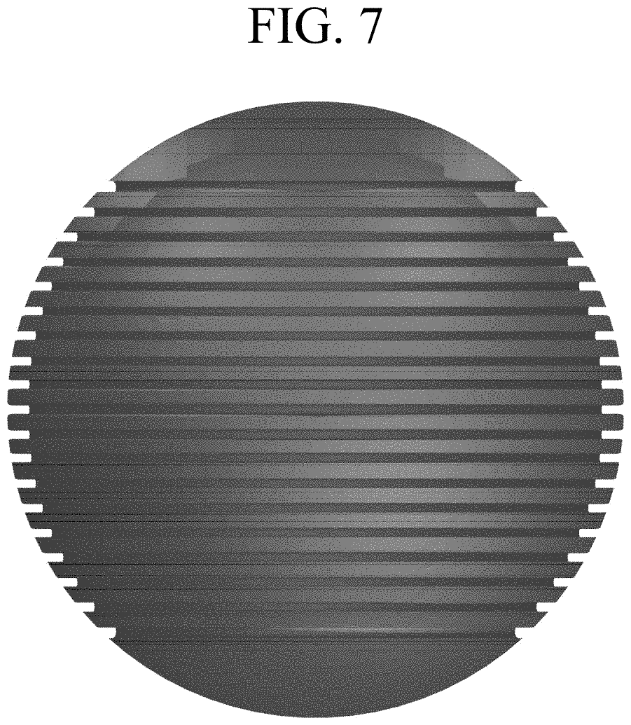

FIG. 6 and FIG. 7 show a top-down and side view of the embodiment of the invention, illustrating the relationship between the grooves and the ungrooved sections.

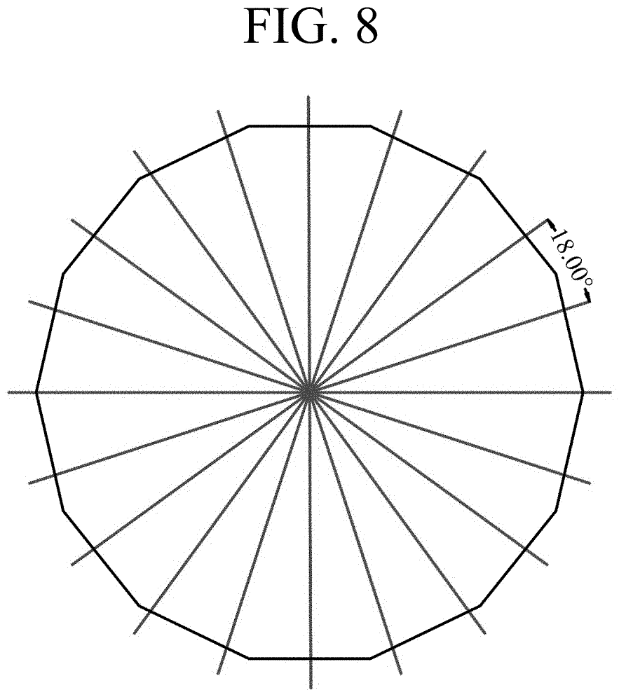

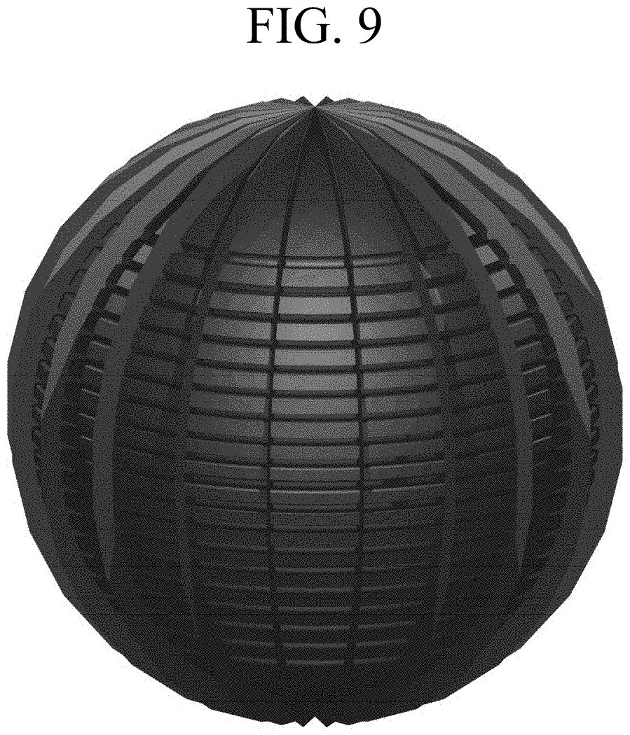

FIG. 8 illustrates the division of the embodiment of the invention into segments of equal arc length, with the specific angle chosen being practical but arbitrary, and other arc measurements/arc distances being suitable to different embodiments.

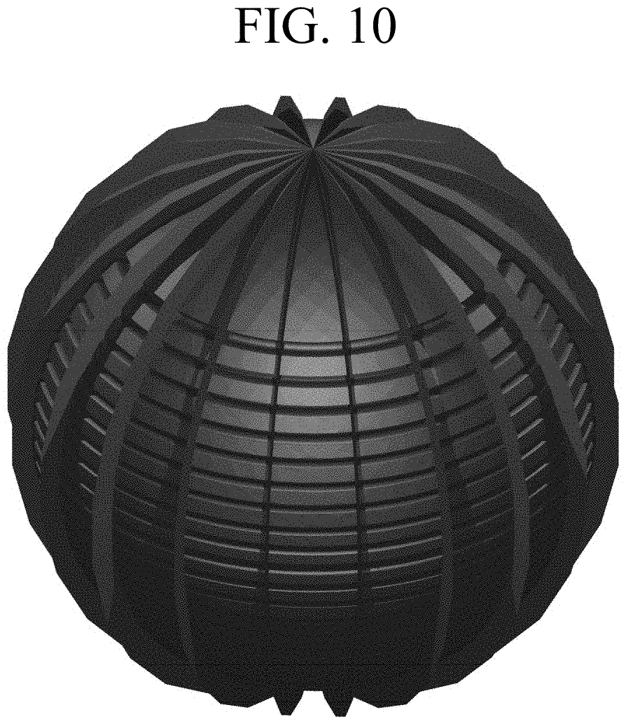

FIG. 9 and FIG. 10 illustrate these arc divisions from side and isometric views, with the red lines illustrating the division of the embodiment and groove lines to facilitate the selective inflow and outflow of ionized fluid/plasma to the invention.

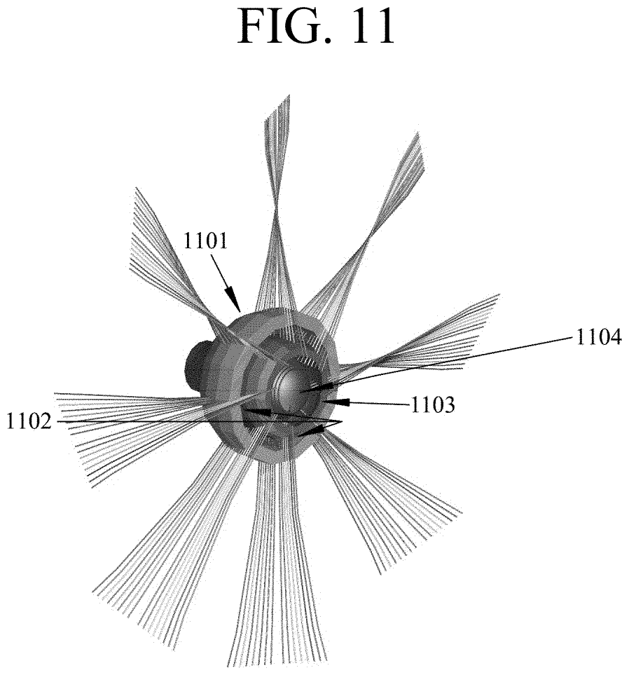

FIG. 11 illustrates the intended placement of the present embodiment of the invention in the invention described in U.S. Utility application Ser. No. 17,128,117, with 1104 indicating the location of the present invention, and 1101, 1102, and 1103 illustrating the relative location of the outer-core shell, the gap between core shells, and the inner-core shell, respectively.

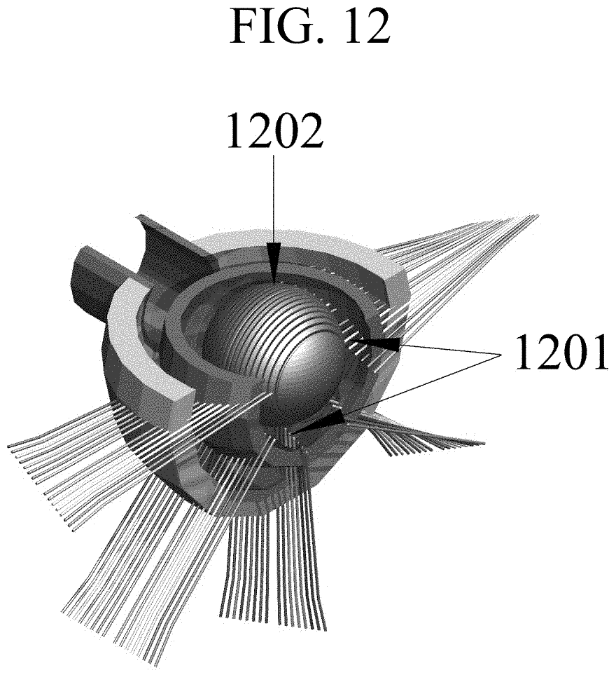

FIG. 12 is a cutaway close-up dimetric northwest (NW) view of the embodiment of the invention placed within the core of the invention described in U.S. Utility application Ser. No. 17,128,117, with 1201 indicating the alignment of the pumping-line ports of the previous invention (as indicated by the colored lines approaching the present invention) with the grooves of the embodiment of the present invention and 1202 being the present invention in situ.

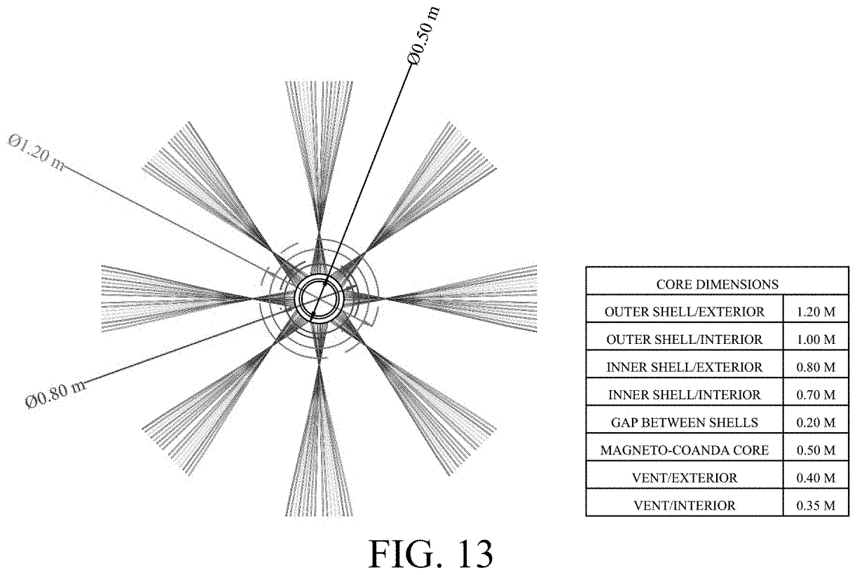

FIG. 13 further illustrates the special relationship and placement of the embodiment of the present invention to the invention described in U.S. Utility application Ser. No. 17,128,117.

### DETAILED DESCRIPTION OF INVENTION

Features of Present Invention

It is a feature of the present invention to allow for the confinement of streams of ionized fluid/plasma within a small void by way of magnetic fields and the Coandă effect.

It is a feature of the present invention to allow for the acceleration of streams of ionized fluid/plasma within a small void by way of magnetic fields and the Coandă effect.

It is a feature of the present invention to allow for the injection or release of ionized fluid/plasma from the confined streams therein at a highly variable rate.

Construction of Invention

The present invention may be constructed of metal of suitable toughness, corrosion resistance, and magnetic properties for its intended purpose, or it may be constructed of ceramic, but only if the sections in and around the grooves are capable of functioning as electromagnets. The electromagnets within the present embodiment of the invention may be of either the conventional electromagnet or superconducting electromagnet type, so long as they respond to control signals to vary the power of the different segments. The primary structure (the sphere) of the invention may be manufactured by any means suitable to the budget and needs of the user, with possible construction methods including casting, milling, or 3D printing. For embodiments of the invention intended to confine plasma, the embodiments' grooves and the surfaces near them should be coated with suitable material to reduce plasma erosion.

The exact dimensions of the grooves in the sphere may vary based on the embodiment of the invention, on the condition that outer dimensions of the groove (near 201) are at least 20% narrower than the widest interior part of the groove (near 202) and the region between them is narrower than either of the two (giving the groove a distinct waist).

The invention may be powered either by a contained power supply, energy transmitted to the invention by way of electromagnetic induction, or by converting part of the heat of the ionized fluid/plasma with which the mechanism interacts into electrical energy, with the magnetohydrodynamic effect being used as an ionized fluid/plasma braking system/partial energy-recovery system.

Control of the field strength of the electromagnets within the invention may be preprogrammed, automatic, or controlled externally by way of radio, optical, or acoustic signals transmitted to the invention by an operator, with the specifics of the control mechanism varying from one embodiment of the invention to the next, depending upon construction constraints and operator needs. The addition of an external control system will be necessary for select embodiments of the invention, with other embodiments not requiring such external control systems.

Finally, if installed in the invention described in U.S. Utility application Ser. No. 17,128,117 (Dec. 20, 2020), the present invention may benefit from some means of support so that the grooves of the present invention readily align with the pumping-line ports of the previous invention. Possible means for this include a fixed mechanical support, if properly aligned, or a variable-height mechanical support, which would allow the operator of the inventions to adjust the alignment of the grooves and pumping-line ports of the present and previous inventions, respectively. An additional possibility for aligning the present invention in the core of the previously mentioned invention is magnetic levitation, if the appropriate apparatus is installed in the previously described invention and the present invention is constructed of magnetic materials, or diamagnetic materials (if the external magnetic field is sufficiently strong). Any other method of stabilization and support of sufficient strength and stability may also be used.

Operation of Invention

Operation of the invention is to be conducted as follows:
1. The invention will be installed in a suitable location for the introduction of ionized fluid/plasma, either in the invention described in U.S. Utility application Ser. No. 17,128,117 or in some other appropriate device or location. (FIG. 11/FIG. 12 indicate ideal placement within the previously described invention.)
2. The outer walls/outer boundaries of the grooves (201) of the invention (FIG. 2) will initially be either uncharged or weakly charged and the inner walls (202) will be fully charged.
3. As appropriately charged ionized fluid/plasma begins to flow into the grooves, sections of the outer boundaries of the grooves (201) are fully charged, excluding those sections into which the ionized fluid/plasma flow is directed.
4. Once the invention has reached full ionized fluid/plasma-containing capacity, the remaining outer boundary sections are charged, thus fully containing the ionized fluid/plasma within the device.
5. The ionized fluid/plasma may be further accelerated by changing the relative strength of the sections of the groove inner walls (202) if directed by the operator or by preprogrammed instructions.
6. Once the ionized fluid/plasma flow has reached the desired speed and energy levels, it may be maintained for a length of time to be determined by either a preprogrammed routine or by an operator, who transmits control signals by way of radio signals, optical signals, or acoustic signals.
7. After the invention has been operated for the desired time, ionized fluid/plasma will be released from the grooves of the invention either omnidirectionally (in which case all sections of the outer walls/outer boundaries of the grooves of the invention are de-energized at the same rate) or through designated exit points, in which case only certain segments of the outer walls of the invention are de-energized. Release of ionized fluid/plasma may either take place gradually or nearly instantaneously.
8. In the event the operator wishes to slow the flow of ionized fluid/plasma within the grooves rather than immediately release it, the polarity of some (or all) of the inner groove-wall magnets may be reversed to increase magnetic resistance to flow.
9. During the deceleration process, the operator may set the system to recover energy from the ionized fluid/plasma flow by way of the magnetohydrodynamic effect, with surplus power being transmitted from an embodiment of the invention by the same means power was transmitted to it, either by way of direct (wired) or inductive power transfer.

### SCOPE OF CLAIMS

Although the present invention has been illustrated and described herein with reference to the preferred embodiments and specific examples thereof, it will be readily apparent to those of requisite skill in the art that other embodiments and examples may perform similar functions and/or achieve like results. All such equivalent embodiments and examples are within the spirit and scope of the present invention, are contemplated thereby, and are intended to be covered by the following claims:

What is claimed is:

1. A system for the confinement of flowing plasma by way of electromagnetic fields and the Coandă effect.

2. A distinctive groove design that facilitates plasma retention by way of the Coandă effect and close-proximity magnetic fields.

3. A mechanism for controlling the inflow and outflow of plasma to a device by way of segmented electromagnetic field regions that are individually controllable.
